(19) United States
(12) Patent Application Publication
(10) Pub. No.: US 2012/0169691 A1
(43) Pub. Date: Jul. 5, 2012

(54) DC-Balancing a Display between Sets of Frames

(75) Inventor: Craig Newswanger, Austin, TX (US)

(73) Assignee: ZEBRA IMAGING, INC., Austin, TX (US)

(21) Appl. No.: 12/982,861

(22) Filed: Dec. 30, 2010

(51) Int. Cl. G09G 5/00

(52) U.S. Cl. 345/211

(57) ABSTRACT

Methods and systems for DC-balancing a display, including displaying a set of frames on a display, the first set of frames being displayed using a corresponding first set of voltages, the first set of voltages being an unbalanced set of voltages, and applying one or more balancing voltages to the display, the one or more balancing voltages being configured to balance the first set of voltages.

### A. RELATED APPLICATIONS INFORMATION

The subject matter of the present application is related to the subject matter of the following commonly assigned, co-pending applications:

U.S. application entitled “DC-Balancing a Display Across Frames” and naming Mark E. Lucente, et al., as inventor(s);

U.S. application entitled “Preprocessing a Current Frame According to Next Frames” and naming Mark E. Lucente, et al., as inventor(s);

U.S. application entitled “Reducing Loading Time of Pixel Values in a Frame” and naming Shih-Che Eric Huang, et al., as inventor(s).

The above-referenced patents and/or patent applications are hereby incorporated by reference herein in their entirety.

### B. BACKGROUND

The invention relates generally to the field of DC-balancing and more specifically to DC-balancing a display between sets of frames.

### C. SUMMARY

In one respect, disclosed is a method for DC-balancing a display, the method including displaying a set of frames on a display, the first set of frames being displayed using a corresponding first set of voltages, the first set of voltages being an unbalanced set of voltages, and applying one or more balancing voltages to the display, the one or more balancing voltages being configured to balance the first set of voltages.

In another respect, disclosed is a system for DC-balancing a display, the system including one or more processors, one or more memory units coupled to the one or more processors, the system being configured to cause a set of frames to be displayed on a display, the first set of frames being displayed using a corresponding first set of voltages, the first set of voltages being an unbalanced set of voltages, and cause one or more balancing voltages to be applied to the display, the one or more balancing voltages being configured to balance the first set of voltages.

In yet another respect, disclosed is a computer program product embodied in a computer-operable medium, the computer program product comprising logic instructions, the logic instructions being effective to cause a set of frames to be displayed on a display, the first set of frames being displayed using a corresponding first set of voltages, the first set of voltages being an unbalanced set of voltages, and cause one or more balancing voltages to be applied to the display, the one or more balancing voltages being configured to balance the first set of voltages.

Numerous additional embodiments are also possible.

### D. BRIEF DESCRIPTION OF THE DRAWINGS

Other objects and advantages of the invention may become apparent upon reading the detailed description and upon reference to the accompanying drawings.

FIG. 1 is a block diagram illustrating a system for controlling a display, in accordance with some embodiments.

FIG. 2(a, b, & c) is a block diagram illustrating a system for DC-balancing a display between sets of frame recordings at three time instances, in accordance with some embodiments.

FIG. 3 is a flow diagram illustrating a method for DC-balancing a display between sets of frame recordings, in accordance with some embodiments.

FIG. 4 is a diagram illustrating various sets of frame sequences for DC-balancing a display, in accordance with some embodiments.

FIG. 5 is a flow diagram illustrating a method for dc-balancing a display across multiple frames, in accordance with some embodiments.

FIG. 6 is a diagram illustrating the adjustment of current frame values for a display according to one or more next frame values, in accordance with some embodiments.

FIG. 7 is a flow diagram illustrating a method for adjusting current-frame values according to the one or more next-frame values, in accordance with some embodiments.

FIG. 8 is a timing diagram illustrating the timeline of a frame, in accordance with some embodiments.

FIG. 9 is a flow diagram illustrating a method for inserting settling time into a frame, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### E. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

In some embodiments, systems and methods for DC-balancing a display are disclosed. In some embodiments, certain types of displays, such as liquid crystal displays, for example, may require DC balancing due to electrolytic action within the LC material, among other reasons. Impurities suspended in the LC material may, for example, migrate and plate onto the display electrodes if voltage is continuously applied in only one direction (either only positive or only negative values are used, for example). The impurities may gradually degrade the performance of the display to where the display is unusable. A typical solution is to display each video frame using both positive and negative voltage values within the time allocated for a frame as it is the absolute value of the voltage that determines the visual effect (the intensity of the particular pixel or subpixel). Using both positive and negative voltages for the same frame, however, reduces the effective frame rate of the display by a factor of two.

In some embodiments where displays requiring DC balancing are used, continuous operation of the display may not be required. The recording of static holograms may be an example of such embodiments. In such embodiments, lasers may be spatially modulated using such displays and then used to record the holograms on the film. In some embodiments, the recordings may be performed in terms of hogels, which form a grid on the film and together generate the 3D image. A recording head consisting of the laser(s), display(s), etc. may be used to record a hogel at a time line by line. The recording head may record one line at a time, for example, and then change directions before recording the next line of hogels. For more information on the recording of hogels on films, please see one or more of the following Zebra Imaging, Inc. issued patents:

U.S. Pat. No. 7,505,186, issued on Mar. 17, 09, titled: “Pulsed-laser systems and methods for producing holographic stereograms”

U.S. Pat. No. 7,245,408, issued on Jul. 17, 07, titled: “Systems and methods for producing wide field-of-view of holographic displays”

U.S. Pat. No. 7,027,197, issued on Apr. 11, 06, titled: “Pulsed-laser systems and methods for producing holographic stereograms”

U.S. Pat. No. 6,806,982, issued on Oct. 19, 04, titled: “Pulsed-laser systems and method for producing holographic stereograms”

U.S. Pat. No. 6,710,900, issued on Mar. 23, 04 titled: “Holograms exposed and processed on plastic substrates”

U.S. Pat. No. 6,661,548, issued on Dec. 9, 03, titled: “Method and apparatus for recording one-step, full-color, full-parallax, holographic . . . ”

U.S. Pat. No. 6,631,016, issued on Oct. 7, 03, titled: “Full-parallax holographic stereograms on curved substrates”

U.S. Pat. No. 6,509,983, issued on Jan. 21, 03, titled: “System and method for adjusting recording laser beam polarization”

U.S. Pat. No. 6,407,833, issued on Jun. 18, 02, titled: “System and method for producing and displaying a one-step, edge-lit hologram”

U.S. Pat. No. 6,330,088, issued on Jan. 11, 01, titled: “Method and apparatus for recording one-step, full-color, full-parallax, holographic . . . ”

U.S. Pat. No. 6,268,942, issued on Jul. 31, 01, titled: “Segmented display system for large, continuous autostereoscopic images”

U.S. Pat. No. 6,266,167, issued on Jul. 24, 01, titled: “Apparatus and method for replicating a hologram using a steerable beam”

U.S. Pat. No. 6,088,140, issued on Jul. 11, 00, titled: “Segmented display system for large, continuous autostereoscopic images”

The above-referenced patents and/or patent applications are hereby incorporated by reference herein in their entirety.

In such and other embodiments where continuous use of such displays is not required, waiting times that may exist between limited time continuous uses may be used as a time for DC balancing the display. One or more additional voltages may be applied during the waiting time in order to DC balance the device. A different set of voltage values may be used for each pixel or subpixel accordingly.

It should be noted that the display may be a black & white display, a color display (where each pixel comprises three subpixels for red, green, and blue), a time-sequential color display (where frames of red, green, and blue are sequentially displayed), etc. A frame may thus represent a single black & white frame; a combined red, green, and blue frame; a frame corresponding to one of the colors, etc.

In some embodiments, alternating positive and negative voltage values may be used every other frame. For example, even frames may be rendered using positive voltages and odd frames may be rendered using negative voltages. In some embodiments, for each line of hogels being rendered (and for each pixel or subpixel) in each frame, a cumulative sum may be kept in order to track the total amount of voltages applied to each pixel for that line of hogels. At the end of each line of hogels and while the recording head is changing directions, in order to record the next line of hogels, a voltage of the same value as the cumulative sum but with opposite sign may be applied to the display. The applied voltage is configured to balance any “excess” voltage that may have been applied to the display during the recording of that line of hogels.

In some embodiments, following the alternating positive and negative voltages, one or more sequences of “white” (full intensity value) frames may be used during the waiting time. The “white” frames may be applied using alternating positive and negative voltages, for example. In these embodiments, a cumulative sum of the voltage values used during each of the lines of hogels may not be kept.

In some embodiments, the electrolytic effect of the voltage may be determined using a known relationship between the electrolytic effect and the applied voltage. Accordingly, a cumulative sum of the electrolytic effect (which may be either positive or negative) may be kept (in some embodiments, in place of the voltage sum). In embodiments where the relationship between applied voltage and the electrolytic effect is not linear, tracking the electrolytic effect provides more accurate results. In these embodiments, a voltage value to be applied may be determined using the cumulative sum of the electrolytic effect by inverting the relationship between the electrolytic effect and the voltage. The voltage value with opposite sign may be then applied to the display during the waiting time in order to DC balance the display.

In some embodiments, additional systems and methods for DC balancing a display are disclosed. In some embodiments, the additional systems and methods disclosed may be implemented in cases where the display may be needed to remain in continuous use.

In some embodiments, the same voltage sign may be used for displaying each pixel in a frame. In some embodiments, an alternating pattern of positive and negative voltages may be used every other frame. In other embodiments, an alternating pattern of two positive (for two frames) and two negative voltages (for another two frames) may be used. In yet other embodiments, an alternating pattern of three positive and three negative voltages may be used, etc.

In some embodiments, an unequal number of alternating positive and negative voltage frames may be used. In embodiments where time-sequential color frames are used, it may be the case that the average of green values in a video is higher in than the average of red and blue values. In those embodiments, the green frames may be displayed using positive voltages and the red and blue frames may be displayed using negative voltages in order to accomplish an average voltage value for the video that is close to zero.

It should also be noted that, in some embodiments, different voltage signs may be used for different pixels/subpixels in the same frame. In some embodiments, a cumulative voltage value may be kept for each pixel/subpixel in each frame. The voltage sign may then be changed in response to the cumulative voltage changing signs. In some embodiments, a separate cumulative sum—and thus a different point of sign change—may be used for each pixel/subpixel in a frame. The following table shows an example of applied voltages, the voltage cumulative sum, and the voltage sign changes for a particular pixel in a frame. In this example, it is assumed that the voltages can range from 0-10 in absolute value.

| Sign | Voltage | Sum |
|---|---|---|
| + | 2 | 2 |
| − | −8 | −6 |
| + | 4 | −2 |
| + | 5 | 3 |
| − | −10 | −7 |
| + | +3 | −4 |
| + | +3 | −1 |
| + | +7 | 6 |
| − | −3 | 3 |

In some embodiments, systems and methods are disclosed for optimizing the performance of a display by adjusting the pixel values in each frame according to a known time response of the display.

In some embodiments, pixel values in a frame that is about to be displayed on the display may be adjusted according to the values of one or more next frames to be displayed on the display. In some embodiments, the display may have a certain time response characteristic. Depending on the frame rates required, there may not be enough time for the loaded pixel values to settle to the desired values, especially when the pixel values are high or when the pixel values differ significantly from the corresponding pixel values in the previous frame.

In some embodiments, the color accuracy with which a current frame is displayed may be partially sacrificed in order to increase the accuracy with which one or more next frames are displayed. For example, if a next frame pixel value is too high and cannot be reached within an allocated time, the corresponding current frame pixel value may be adjusted towards the next value, for example, in order to increase the accuracy of the pixel for the next frame. It should be noted that, since the time allocated to different pixels in a frame may be different (for example, due to the scanning nature of the displays), an optimum amount of adjustment may be different for different pixels even if the values of the current and next pixel values are equal.

In some embodiments, additional next pixels may be also monitored and the value of the current pixel may be adjusted according to more than just the next pixel value. In yet other embodiments, previous pixels values may be also considered when adjusting the current pixel value.

In some embodiments, an error function may be formed, the error function being indicative of a visual error caused by the difference between assigned pixel value and actual pixel value. The error function may include knowledge of how perceptible differences in pixel values may be to the human eye. In embodiments where the current pixel value is to be adjusted according to the value of the corresponding next pixel value, a combined error function for the current pixel value and next pixel value may be formed and minimized in order to accomplish the best compromise for the values of the current pixel value and the next pixel value.

It should also be noted that the pixel value adjustments may be used in applications with black and white displays, color displays with red, green, and blue subpixels, color displays with time sequential frames of red, green, and blue, etc. In time sequential applications, for example, different error functions may be used for the different colors as green is typically visually more important than red, which is more visually important than blue. This information may be reflected in the error functions formed for each color. As blue is not as important, for example, a greater sacrifice in blue colors may be made in order to achieve greater performance in the more important green colors.

In some embodiments, systems and methods are disclosed for minimizing the time for loading the pixels for a frame to be displayed onto a display. That is, the time between when the first and last pixel values are loaded on display is to be minimized.

Certain displays such as liquid crystal displays exhibit specific time responses with respect to the loading of pixel values. That is, when a pixel value is loaded onto the display, the pixel acquires that value over a certain period and with a certain time characteristic. For typical displays such as liquid crystal displays, the pixel values are loaded in a scanning pattern; for example, the pixels may be loaded from top left to bottom right. A reduced time between the loading of the first and last pixels may thus increase the uniformity and general quality of the display.

Typically, the scanning pattern occurs substantially over the time allocated to each frame by the frame refresh rate of the display (the frame period, T). A backlight used to illuminate the pixels and display the image is typically flashed towards the end of the frame period. In such embodiments,

In some embodiments, the time between the loading of the first and last pixels may be decreased by compressing the time towards the beginning of the frame period. With the backlight being flashed at the end of the period, the relative difference between the first and last pixel settling times is greatly reduced.

In some embodiments, to further increase uniformity across the display panel, the values for each pixel may be stored near each of the pixels as the pixel values are loaded onto each pixel. The pixels may be then loaded onto the pixels from the pixel storage substantially simultaneously, thus providing substantially equal settling times for the pixels of the display panel before the backlight is flashed.

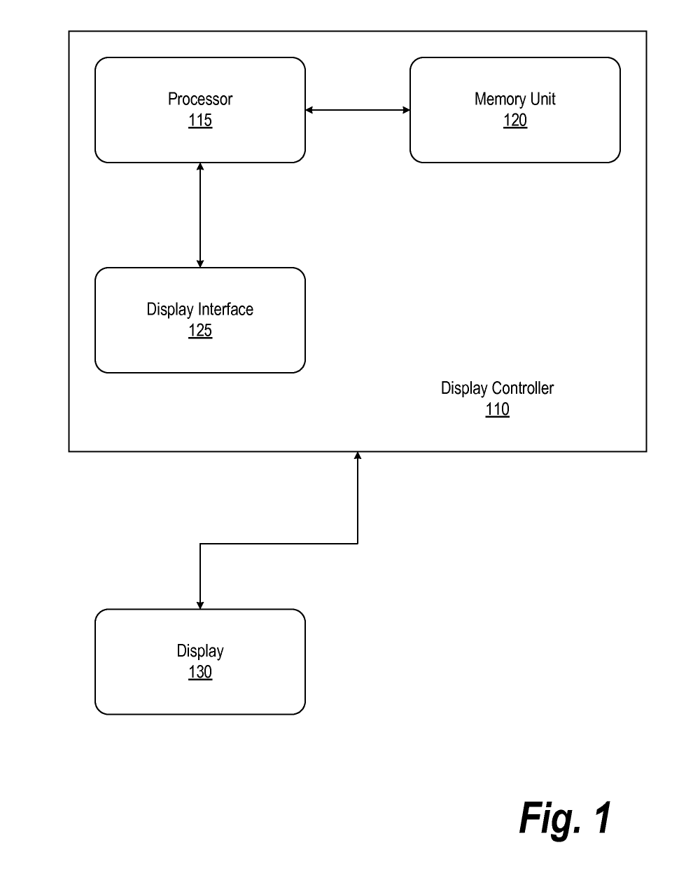

FIG. 1 is a block diagram illustrating a system for controlling a display, in accordance with some embodiments.

In some embodiments, the systems and methods for controlling a display may be implemented using one or more processors such as processor 115 and one or more memory units coupled to the processors such as memory unit 120. In some embodiments, processor 115 and memory unit 120 may be part of display controller 110, which is configured to drive an attached display such as display 130. Display controller 110 may also comprise display interface 125 for facilitating the interface between display controller 110 with display 130.

In some embodiments, display controller 110 is configured to receive data to be displayed on display 130. The data may be processed and adapted for a better visual experience on display 130. In some embodiments, the data may be processed according to the various characteristics of display 130 including such as the display's DC-balancing requirements, time response characteristics, etc.

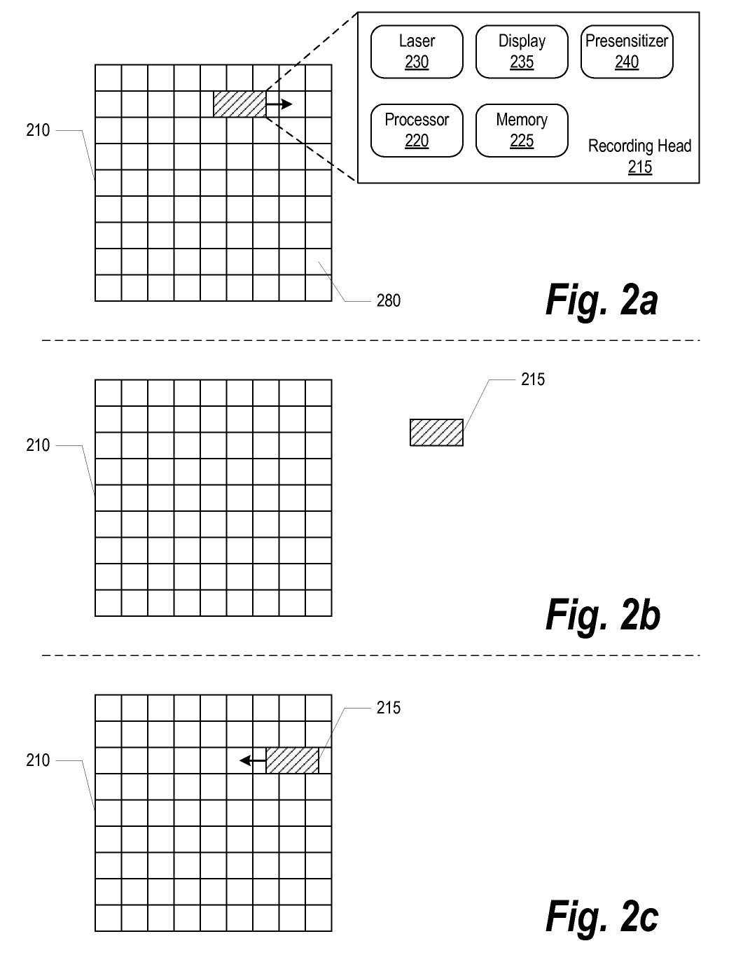

FIGS. 2(a, b, & c) is a block diagram illustrating a system for DC-balancing a display between sets of frame recordings at three time instances, in accordance with some embodiments.

In some embodiments, recording head 215 is configured to record hogels (such as hogel 280, for example) on film 210. In some embodiments, a grid of hogels is recorded on each film such that when the film is illuminated, a 3D image is generated. Recording head 215 may comprise or be coupled to processor 220 and memory 225, which are configured to contribute to the implementation of the functionality of recording head 215. Recording head 215 may also comprise presensitizer 240, which may be configured to presensitize the film prior to the recording of hogels on the film. In some embodiments, presensitizing the film may aid in the efficiency of the recording of hogels on the film.

Recording head 215 may also comprise laser 230 and display 235. In some embodiments, display 235 may be configured to spatially modulate laser 230 (or combinations of laser beams from laser 230) according to the information that is to be recorded in each hogel on film 210. In some embodiments, display 235 may be a display such as a liquid crystal display that requires DC balancing as described above.

In some embodiments, recording head 215 is configured to record hogels on film 210 in a scanning pattern. For example, hogels may be recorded from top left to bottom right. At the end of each row of recorded hogels, recording head 215 may be configured to change directions and move down one row in order to record the next row of hogels.

In some embodiments, the turning time needed for recording head 215 to switch from one row to the next row may be used to DC balance the display. During the recording of a row of hogels, a cumulative sum of the voltage applied to each pixel in each frame in that row of hogels may be kept. At the end of each row of hogels and as the recording head 215 switching to recording the next row of hogels a voltage, per pixel, with opposite sign but same magnitude as the cumulative sum for that row is applied to each pixel of the display. Accordingly, the total amount of voltage applied to the display per row is now equal to zero. In some embodiments, in order to keep the cumulative sum as close to zero as possible during the recording of the row of hogels, an alternating positive and negative voltage pattern may be used. For example, the voltage sign may change every other frame, every two frames, etc.

In FIG. 2a, recording head 215 is shown travelling towards the “right” relative to film 210 while recording a first row of hogels. In FIG. 2b, recording head 215 is shown while switching to record the next row of hogels. In some embodiments, it is during this switching time when display 235 may be DC balanced. In FIG. 2c, recording head 215 is shown after the recording has switched to recording the next row of hogels after the DC balancing has been performed.

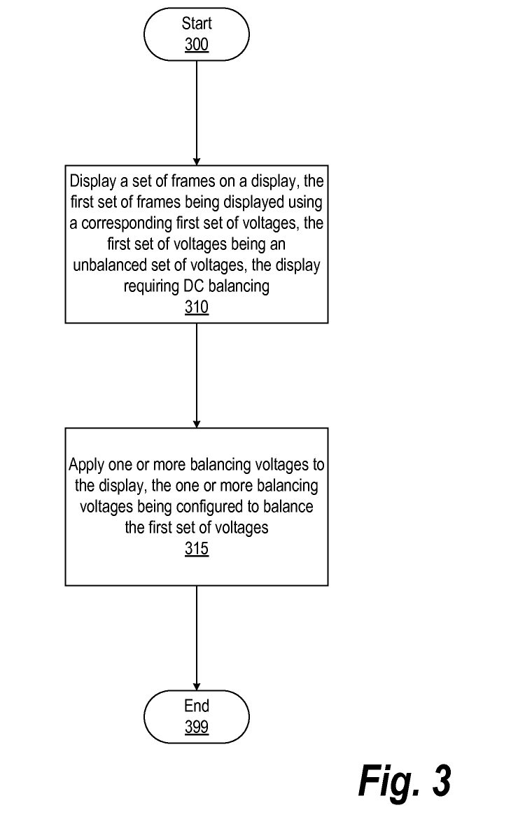

FIG. 3 is a flow diagram illustrating a method for DC-balancing a display between sets of frame recordings, in accordance with some embodiments.

In some embodiments, the method illustrated in FIG. 3 may be performed by one or more of the systems illustrated in FIG. 1 and FIG. 2.

Processing begins at 300 whereupon, at block 310, a set of frames is displayed on a display, the first set of frames being displayed using a corresponding first set of voltages, the first set of voltages being an unbalanced set of voltages, the display requiring DC balancing.

At block 320, one or more balancing voltages are applied to the display, the one or more balancing voltages being configured to balance the first set of voltages.

Processing subsequently ends at 399.

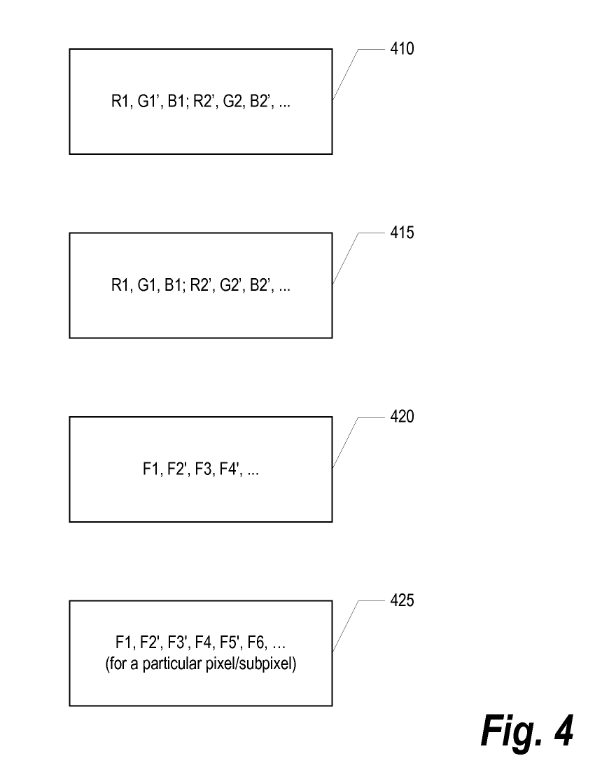

FIG. 4 is a diagram illustrating various sets of frame sequences for DC-balancing a display, in accordance with some embodiments.

In some embodiments, displays, such as liquid crystal displays require DC balancing for more reliable operation as described above. Various sequences of frames may be used with various combinations of positive and negative voltages.

Sequence 410 represents a sequence of frames in a time-sequential color frame application. In time-sequential color applications, red, green, and blue subframes are displayed using a “monochrome” display sequentially in time. In a typical scenario, each frame is processed by sequentially displaying the frame's red component, the frame's green component, and the frame's blue component. In sequence 410, a typical R, G, B subframe sequence may be used with every other subframe being displayed using alternating positive and negative voltages. Thus, a red subframe is first displayed using positive voltages, for example, and the next subframe is displayed using a negative voltage. Though the display may not completely DC balanced (as the values from subframe to subframe are not the same), over a large number of frames/subframes, the overall voltage applied to the display per pixel should average to a number close to zero.

Sequence 415 represents an alternative sequence of frames/subframes also in a time-sequential color frame application. In this example, each frame (which includes a red, a green, and a blue subframe) is displayed using alternating positive and negative voltages for each frame. As with the prior sequence, in these embodiments, the display may not completely DC balanced. However, over a large number of frames, the overall voltage applied to the display per pixel should average to a number close to zero.

Sequence 420 represents a sequence that may be used with a monochrome display or a display comprising red, green, and blue subpixels for each pixel. In this example, alternating positive and negative voltages may be used for each frame. As with the prior sequences, in these embodiments, the display may not completely DC balanced, but over a large number of frames, the overall voltage applied to the display per pixel should average to a number close to zero.

Sequence 425 represents a sequence of frames where the sign of the voltage being used can change independently for each pixel within a frame. In these embodiments, a running sum of the voltage applied to each pixel for each frame may be kept. The sign of the voltage applied to each pixel is then independently changed when the running sum changes signs. Thus, the running sum of the voltage applied to each pixel for each frame is kept as close to zero as possible during the operation of the display.

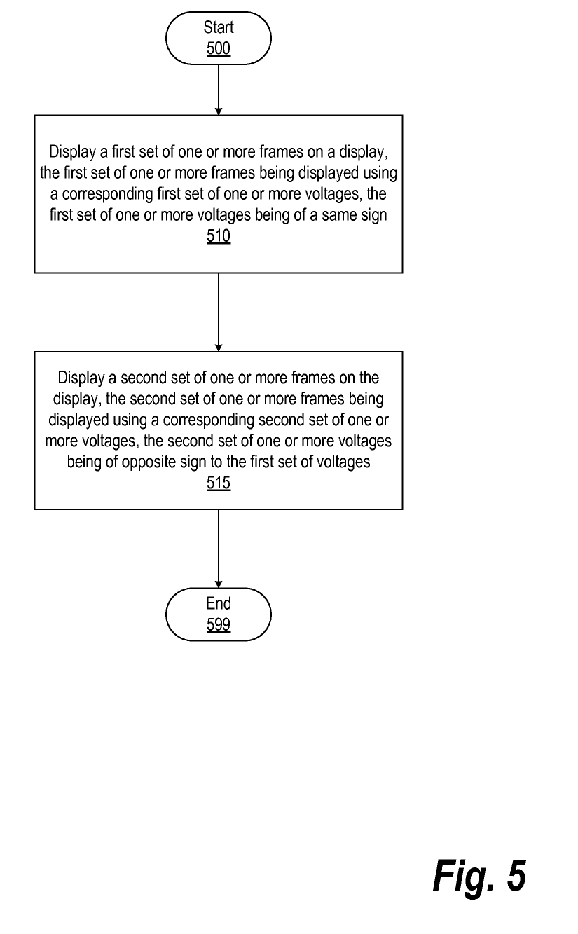

FIG. 5 is a flow diagram illustrating a method for dc-balancing a display across multiple frames, in accordance with some embodiments.

In some embodiments, the method illustrated in FIG. 5 may be performed by one or more of the systems illustrated in FIG. 1.

Processing begins at block 500 whereupon, at block 510, a first set of one or more frames is displayed on a display, the first set of one or more frames being displayed using a corresponding first set of one or more voltages, the first set of one or more voltages being of a same sign, the display requiring DC balancing.

At block 515, a second set of one or more frames on the display, the second set of one or more frames being displayed using a corresponding second set of one or more voltages, the second set of one or more voltages being of opposite sign to the first set of voltages.

Processing subsequently ends at 599.

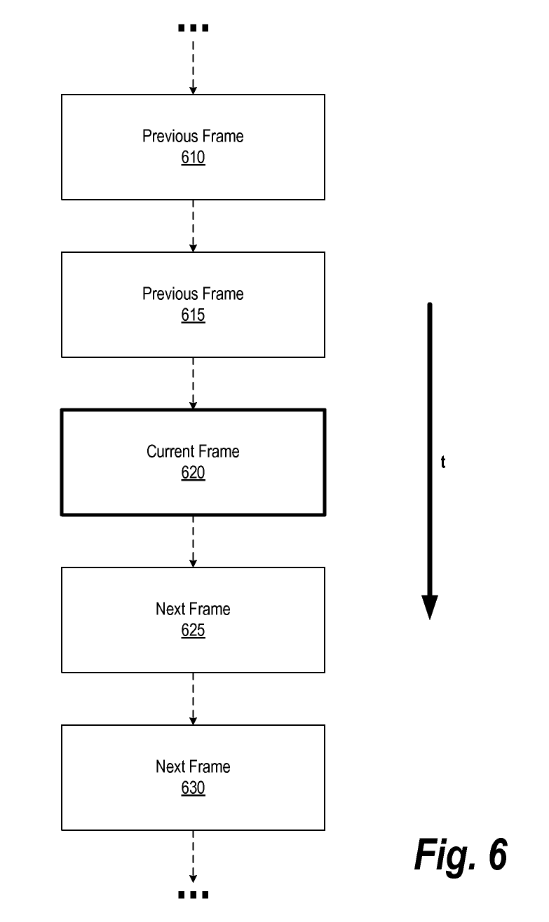

FIG. 6 is a diagram illustrating the adjustment of current frame values for a display according to one or more next frame values, in accordance with some embodiments.

In some embodiments, the values for current frame 620 may be adjusted according to the values of one or more next frame values such as next frame 625 and next frame 630. In alternative embodiments, in addition to the next frames, the values for current frame 620 may be adjusted according to the values of one or more previous frame values such as previous frame 610 and previous frame 615.

In some embodiments, the display may have a certain time response characteristic. Depending on the frame rates required, there may not be enough time for the loaded pixel values to settle to the desired values, especially when the pixel values are high and/or when the pixel values differ significantly from the corresponding pixel values in the previous frame.

In some embodiments, the color accuracy with which current frame 620 is displayed may be partially sacrificed in order to increase the accuracy with which one or more next frames are displayed. For example, if a next frame pixel value is too high and cannot be reached within an allocated time, the corresponding current frame pixel value may be adjusted towards the next value, for example, in order to increase the accuracy of the pixel for the next frame. It should be noted that, since the time allocated to separate pixels in a frame may be different (for example, due to the scanning nature of the displays), an optimum amount of adjustment may be different for the separate pixels even if the values of the current and next pixel values are equal.

In some embodiments, an error function may be formed, the error function being indicative of a visual error caused by the difference between assigned pixel value and actual pixel value. The error function may include knowledge of how perceptible differences in pixel values may be to the human eye. In embodiments where the current pixel value is to be adjusted according to the value of the corresponding next pixel value, a combined error function for the current pixel value and next pixel value may be formed and minimized in order to accomplish the best compromise for the values of the current pixel value and the next pixel value.

It should also be noted that the pixel value adjustments may be used in applications with black and white displays, color displays with red, green, and blue subpixels, color displays with time sequential frames of red, green, and blue, etc. In time sequential applications, for example, different error functions may be used for the different colors as green is typically visually more important than red, which is more visually important than blue. This information may be reflected in the error functions formed for each color. As blue is not as important, for example, a greater sacrifice in blue colors may be made in order to achieve greater performance in the more important green colors.

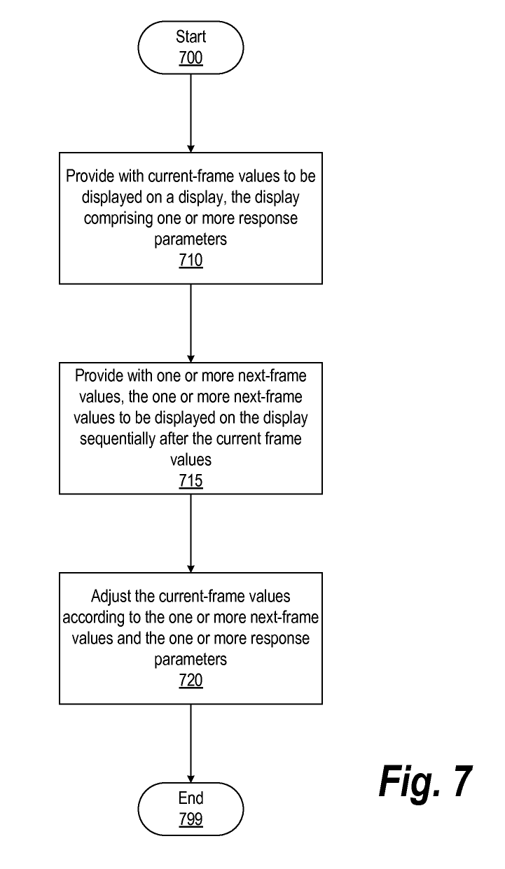

FIG. 7 is a flow diagram illustrating a method for adjusting current-frame values according to the one or more next-frame values, in accordance with some embodiments.

In some embodiments, the method illustrated in FIG. 7 may be performed by one or more of the systems illustrated in FIG. 1.

Processing begins at 700 whereupon, at block 710, current-frame values to be displayed on a display are provided, the display comprising one or more response parameters.

At block 715, one or more next-frame values are provided, the one or more next-frame values to be displayed on the display sequentially after the current frame values.

At block 720, the current-frame values are adjusted according to the one or more next-frame values and the one or more response parameters.

Processing subsequently ends at 799.

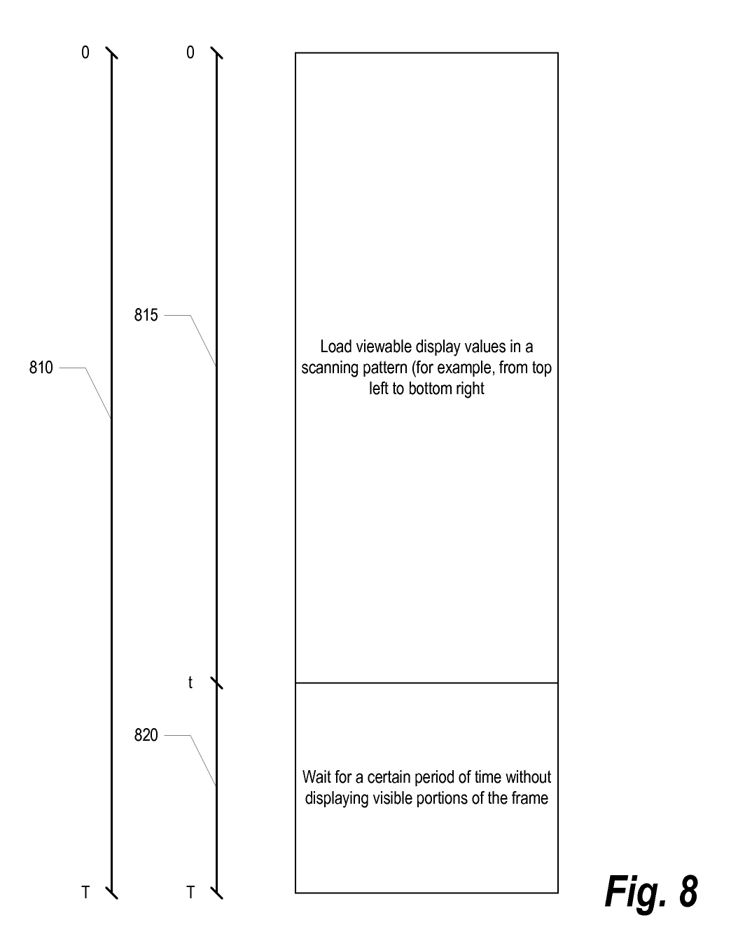

FIG. 8 is a timing diagram illustrating the timeline of a frame, in accordance with some embodiments.

In this example, timeline 810 shows the timing for displaying a frame on a display (such as a liquid crystal display) from time 0 to time T is shown. An alternative timeline shows an alternative timing for displaying a frame on the display. The alternative timeline comprises two sections: section 815 (from time 0 to time t) and section 820 (from time t to time T). Displays such as a liquid crystal display exhibit certain time response characteristics that may affect the performance of the display. For example, a certain time delay may exist from the time when a value is loaded into a pixel to when the pixel actually reaches that value. In some embodiments, the time response of a display may affect the quality of the image generated including the uniformity of the image (in terms of brightness, for example).

According to timeline 810, the scanning and corresponding loading of values to the pixels for a given frame begins at time 0 (which may correspond to the top left pixel of the frame, for example) and ends close to time T (which may correspond to the bottom right pixel of the frame, for example). On a liquid crystal display, for example, the pixels may then be displayed by flashing a backlight of the display close to time T. In this embodiments, the pixels loaded last (close to time T) have very little time to settle into their values compared to pixels that were loaded first.

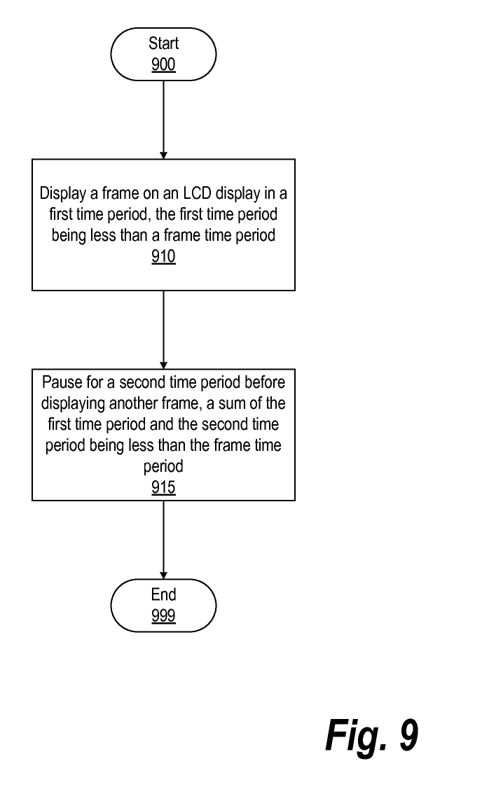

FIG. 9 is a flow diagram illustrating a method for inserting settling time into a frame, in accordance with some embodiments.

In some embodiments, the method illustrated in FIG. 9 may be performed by one or more of the systems illustrated in FIG. 1.

Processing begins at 900 whereupon, at block 910, a frame is displayed on an LCD display in a first time period, the first time period being less than a frame time period.

At block 920, for a second time period a pause is made before displaying another frame, a sum of the first time period and the second time period being less than the frame time period.

Processing subsequently ends at 999.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method for DC-balancing a display, the method comprising:
displaying a set of frames on a display, the first set of frames being displayed using a corresponding first set of voltages, the first set of voltages being an unbalanced set of voltages; and
applying one or more balancing voltages to the display, the one or more balancing voltages being configured to balance the first set of voltages.

2. The method of claim 1, further comprising:
displaying additional sets of frames on the display, the additional sets of frames being displayed using corresponding additional sets of voltages, the additional sets of voltages being unbalanced sets of voltages; and
applying additional sets of balancing voltages to the display, each additional set of balancing voltages being applied after the displaying of each corresponding additional set of frames, the one or more balancing voltages being configured to balance the first set of voltages.

3. The method of claim 1, further comprising determining a sum of the first set of voltages, the one or more balancing voltages being equal to the negative of the sum of the first set of voltages.

4. The method of claim 1, where an electrolytic effect of the first set of voltages is balanced by another electrolytic effect of the one or more balancing voltages.

5. The method of claim 1, where the one or more balancing voltages comprises a maximum positive voltage or a maximum negative voltage.

6. The method of claim 1, where the first set of voltages comprise of voltages of alternate positive and negative voltages.

7. The method of claim 1, where displaying the set of frames on the display corresponds to a recording of one or more hogels on a film.

8. A system for DC-balancing a display, the system comprising:
one or more processors;
one or more memory units coupled to the one or more processors;
the system being configured to:
cause a set of frames to be displayed on a display, the first set of frames being displayed using a corresponding first set of voltages, the first set of voltages being an unbalanced set of voltages; and
cause one or more balancing voltages to be applied to the display, the one or more balancing voltages being configured to balance the first set of voltages.

9. The system of claim 8, the system being further configured to:
cause additional sets of frames to be displayed on the display, the additional sets of frames being displayed using corresponding additional sets of voltages, the additional sets of voltages being unbalanced sets of voltages; and
cause additional sets of balancing voltages to be applied to the display, each additional set of balancing voltages being applied after the displaying of each corresponding additional set of frames, the one or more balancing voltages being configured to balance the first set of voltages.

10. The system of claim 8, the system being further configured to determine a sum of the first set of voltages, the one or more balancing voltages being equal to the negative of the sum of the first set of voltages.

11. The system of claim 8, where an electrolytic effect of the first set of voltages is balanced by another electrolytic effect of the one or more balancing voltages.

12. The system of claim 8, where the one or more balancing voltages comprises a maximum positive voltage or a maximum negative voltage.

13. The system of claim 8, where the first set of voltages comprise of voltages of alternate positive and negative voltages.

14. The system of claim 8, where the system being configured to cause the set of frames to be displayed on the display corresponds to a recording of one or more hogels on a film.

15. A computer program product embodied in a computer-operable medium, the computer program product comprising logic instructions, the logic instructions being effective to:
cause a set of frames to be displayed on a display, the first set of frames being displayed using a corresponding first set of voltages, the first set of voltages being an unbalanced set of voltages; and
cause one or more balancing voltages to be applied to the display, the one or more balancing voltages being configured to balance the first set of voltages.

16. The product of claim 8, the logic instructions being further effective to:
cause additional sets of frames to be displayed on the display, the additional sets of frames being displayed using corresponding additional sets of voltages, the additional sets of voltages being unbalanced sets of voltages; and
cause additional sets of balancing voltages to be applied to the display, each additional set of balancing voltages being applied after the displaying of each corresponding additional set of frames, the one or more balancing voltages being configured to balance the first set of voltages.

17. The product of claim 8, the logic instructions being further configured to determine a sum of the first set of voltages, the one or more balancing voltages being equal to the negative of the sum of the first set of voltages.

18. The product of claim 8, where an electrolytic effect of the first set of voltages is balanced by another electrolytic effect of the one or more balancing voltages.

19. The product of claim 8, where the one or more balancing voltages comprises a maximum positive voltage or a maximum negative voltage.

20. The product of claim 8, where the first set of voltages comprise of voltages of alternate positive and negative voltages.
